(19) United States
(12) Patent Application Publication
(10) Pub. No.: US 2026/0328502 A1
(43) Pub. Date: Oct. 22, 2026

(54) LIQUID COOLING DEVICE

(71) Applicant: SHENZHEN APALTEK CO., LTD., Shenzhen (CN)

(72) Inventors: Dagao ZHENG, Shenzhen (CN); Song LIANG, Shenzhen (CN); Wenlang CHEN, Shenzhen (CN)

(21) Appl. No.: 19/440,564

(22) Filed: Jan. 5, 2026

(30) Foreign Application Priority Data
Apr. 17, 2025 (CN) 2025104902101

(51) Int. Cl. F28F 27/00; F28F 3/04; F28F 3/12

(52) U.S. Cl. CPC F28F 27/00; F28F 3/04; F28F 3/12; F28F 2265/16

(57) ABSTRACT

A liquid cooling device for a coolant flowing therein includes a radiator and a leakage detection module. The radiator includes a connecting tank, a transition tank, and a plurality of cooling fins communicated to the connecting tank and the transition tank. The leakage detection module is arranged on the transition tank and includes an additional tank communicated to the transition tank, an elastic bladder arranged in the additional tank and having a pressure value, and a monitoring assembly arranged on the additional tank to detect the pressure value. The coolant is filled in the connecting tank, the transition tank, the cooling fins, and the additional tank. When the liquid cooling device leaks, a volume of the elastic bladder changes such that the pressure value changes and is detected by the monitoring assembly. The liquid cooling device is therefore being accurately detected for leakage to allow users to handle it immediately.

### BACKGROUND OF THE INVENTION

### Technical Field

The present disclosure relates to the field of liquid cooling, particularly to a liquid cooling device capable of detecting leaks.

### Description of Related Art

In the field of liquid cooling, liquid cooling devices such as liquid cooling heads, radiators, and liquid cooling plates are often disassembled into multiple parts to make manufacturing and assembly easier. These parts are then assembled together by screwing, welding, latching, or embedding, which creates a gap between each part. Therefore, it is desirable to improve the sealing performance between the parts during design and assembly. However, since most common sealing structures use rubber rings, these structures are prone to aging or deformation leading to failure after prolonged use. Some liquid cooling devices therefore incorporate detectors to monitor specific locations, so as to allow users to detect and deal with leaks immediately.

However, existing liquid cooling devices only have detectors arranged at specific locations, such that not all joints between components may be monitored simultaneously and the user will not be aware of leakage immediately if it occurs in the location where a detector is not arranged. In addition, arranging detectors in multiple locations not only increases production costs and assembly time, but also complicates cable management.

In view of the above, the inventor seeks to overcome the aforementioned drawbacks associated with the current technology and aims to provide an effective solution through extensive researches along with utilization of academic principles and knowledge.

### SUMMARY OF THE INVENTION

The primary objective of the present disclosure is to accurately monitor the entire liquid cooling device for leakage, so as to allow users to handle them immediately.

To accomplish the aforementioned objective, the present disclosure provides a liquid cooling device used for connecting an inlet tube and an outlet tube of a liquid cooling head, so as to form a closed loop for a coolant flowing therein. The liquid cooling device includes a radiator and a leakage detection module. The radiator includes a connecting tank, a transition tank, and a plurality of cooling fins. The connecting tank has an inlet chamber and an outlet chamber adjacent to each other. Two ends of some of each of the cooling fins are respectively communicated to the inlet chamber and the transition tank. Two ends of the others of each of the cooling fins are respectively communicated to the outlet chamber and the transition tank. The inlet chamber is configured to connect the inlet tube. The outlet chamber is configured to connect the outlet tube. The leakage detection module is arranged on the transition tank and includes an additional tank, an elastic bladder, and a monitoring assembly. The additional tank is communicated to the transition tank. The elastic bladder is arranged in the additional tank and has a pressure value. The monitoring assembly is arranged on the additional tank to detect the pressure value. The coolant is filled in the liquid cooling head, the inlet tube, the outlet tube, the connecting tank, the transition tank, the cooling fins, and the additional tank. When the liquid cooling device leaks, a volume of the elastic bladder changes such that the pressure value changes and is detected by the monitoring assembly.

Another aspect of the present disclosure provides that the additional tank includes a hollow casing, a connecting seat, and a sealing cover, the hollow casing is arranged on the transition tank and communicated to the transition tank, the connecting seat is arranged on a side of the hollow casing, the elastic bladder penetrates the connecting seat to make a part of the elastic bladder be accommodated in the hollow casing, the monitoring assembly is arranged on the connecting seat and corresponding to another part of the elastic bladder, the sealing cover is arranged on the connecting seat and seals and covers the monitoring assembly and the part of the elastic bladder corresponding to the monitoring assembly.

Another aspect of the present disclosure provides that the connecting seat has a through slot and am abutting surface located in the through slot, the elastic bladder has a pouch, a fixing portion, and a cavity, the pouch penetrates the through slot to make the fixing portion abut against the abutting surface, the cavity is extended from the fixing portion toward an interior of the pouch.

Another aspect of the present disclosure provides that the connecting seat further has an annular groove, the annular groove is concave from the abutting surface, the elastic bladder further has a positioning convex ring, the positioning convex ring is extended from the fixing portion and fixed in the annular groove.

Another aspect of the present disclosure provides that the additional tank further includes a pressing member, the pressing member is accommodated in the sealing cover, the fixing portion is clamped between the connecting seat and the pressing member.

Another aspect of the present disclosure provides that the pressing member has an outer thread, the sealing cover has an inner thread, the outer thread is threadedly engaged with the inner thread to fix the pressing member in the sealing cover.

Another aspect of the present disclosure provides that the pressing member has a through hole and an accommodated groove communicated to each other and configured coaxially, the accommodated groove is communicated to the cavity through the through hole, the monitoring assembly is accommodated in the accommodated groove and includes a circuit board, a sensor, and a pair of waterproof rings, the sensor is arranged on the circuit board, each of the waterproof rings is fixed in the accommodated groove and abutted against two opposite sides of the circuit board.

Another aspect of the present disclosure provides that the sensor is arranged on one side of the circuit board and surrounded by the corresponding waterproof ring.

Another aspect of the present disclosure provides that the sealing cover includes a cover plate and a sleeve, the sleeve is extended from the cover plate and accommodated in the through slot, the pressing member is accommodated in the sleeve.

Another aspect of the present disclosure provides that the additional tank further includes a sealing washer, the sealing washer is adapted to sheathe the sleeve and elastically abutted between the connecting seat and the cover plate.

In the liquid cooling device of the present disclosure, the additional tank is communicated to the transition tank, such that the coolant may be filled into the connecting tank, the transition tank, the cooling fins, and the additional tank. In addition, the monitoring assembly detects the pressure value of the elastic bladder in the additional tank. Therefore, the volume of the elastic bladder changes when the liquid cooling device leaks, such that the pressure value changes and is detected by the monitoring assembly, so as to accurately monitor the entire liquid cooling device for leakage to allow users to handle them immediately.

### BRIEF DESCRIPTION OF THE DRAWINGS

FIG. 1 is a perspective view of the present disclosure;

FIG. 2 is a cross-sectional top view of the radiator of the present disclosure;

FIG. 3 is a partial exploded view of the radiator and the leakage detection module of the present disclosure;

FIG. 4 is an exploded view of the leakage detection module of the present disclosure;

FIG. 5 is an exploded view of the pressing member and the monitoring assembly of the present disclosure;

FIG. 6 is a cross-sectional side view of the present disclosure; and

FIG. 7 is a partial enlarged view of FIG. 6.

### DETAILED DESCRIPTION

It is to be understood that the terms for indicating positions and the location relation, for example “front”, “rear”, “left”, “right”, “front end”, “rear end”, “distal end”, “longitudinal direction”, “lateral direction”, “vertical direction”, “top” and “bottom”, are based on the positions and the location relation disclosed in the drawings, and only used for disclosing the present disclosure and not used for indicating or implying the specified location of the device or the components or the specified structure and operation in certain location, thus the present disclosure is not intended to be limiting.

As used herein and not otherwise defined, the terms "substantially" and "approximately" are used to describe and describe small changes. When used in connection with an event or situation, the terms may include the precise moment at which the event or situation occurs, as well as the event or situation occurring to a close approximation. For example, when combined with a numerical value, the terms may include a range of variation equal to or less than ±5% of the numerical value, such as equal to or less than ±4%, equal to or less than ±3%, equal to or less than ±2%, equal to or less than ±1%, equal to or less than ±0.5%, equal to or less than ±0.1%, or equal to or less than ±0.05%.

The technical contents of the present disclosure will become apparent with the detailed description of embodiments and the accompanied drawings as follows. However, it shall be noted that the accompanied drawings are for illustrative purposes only such that they shall not be used to restrict the scope of the present disclosure.

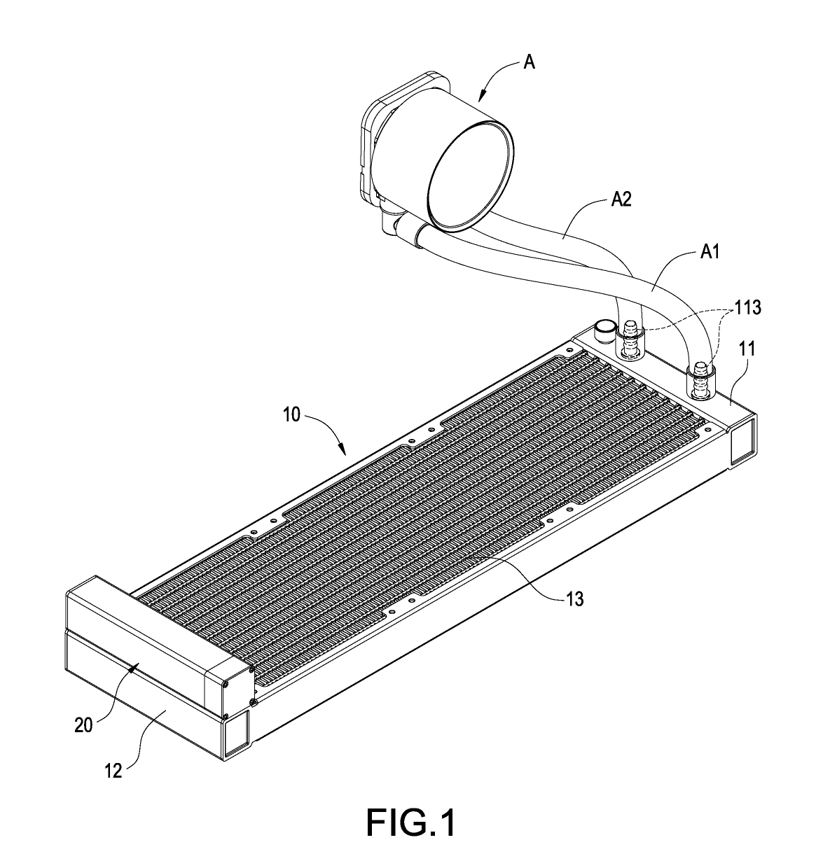

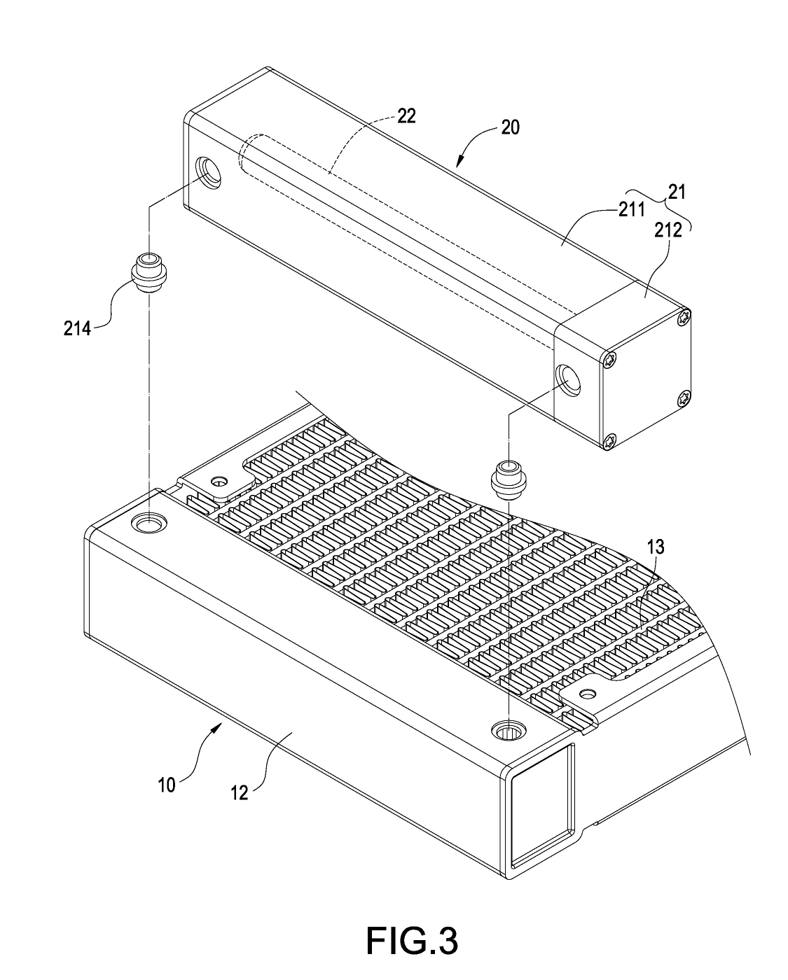

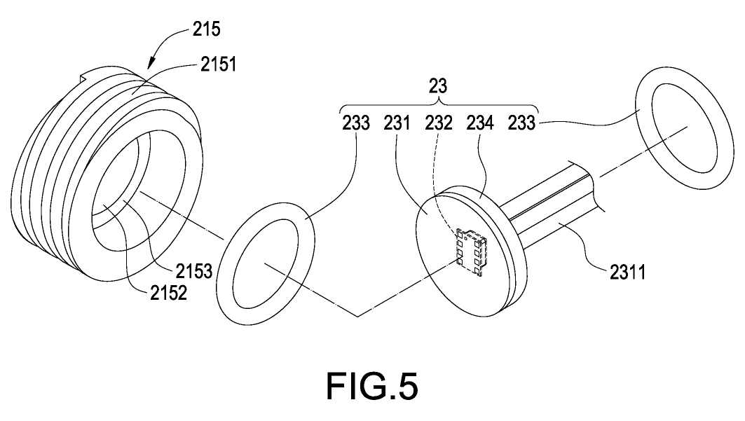

The present disclosure provides a liquid cooling device, which is used for connecting an inlet tube A1 and an outlet tube A2 of a liquid cooling head A to form a closed loop for a coolant (not shown in figures) flowing therein, so as to cool a heat source (not shown in figures) that is attached by the liquid cooling device A. Please refer to FIGS. 1, 2, 3, 4 and 5 the liquid cooling device of the present disclosure includes a radiator 10 and a leakage detection module 20.

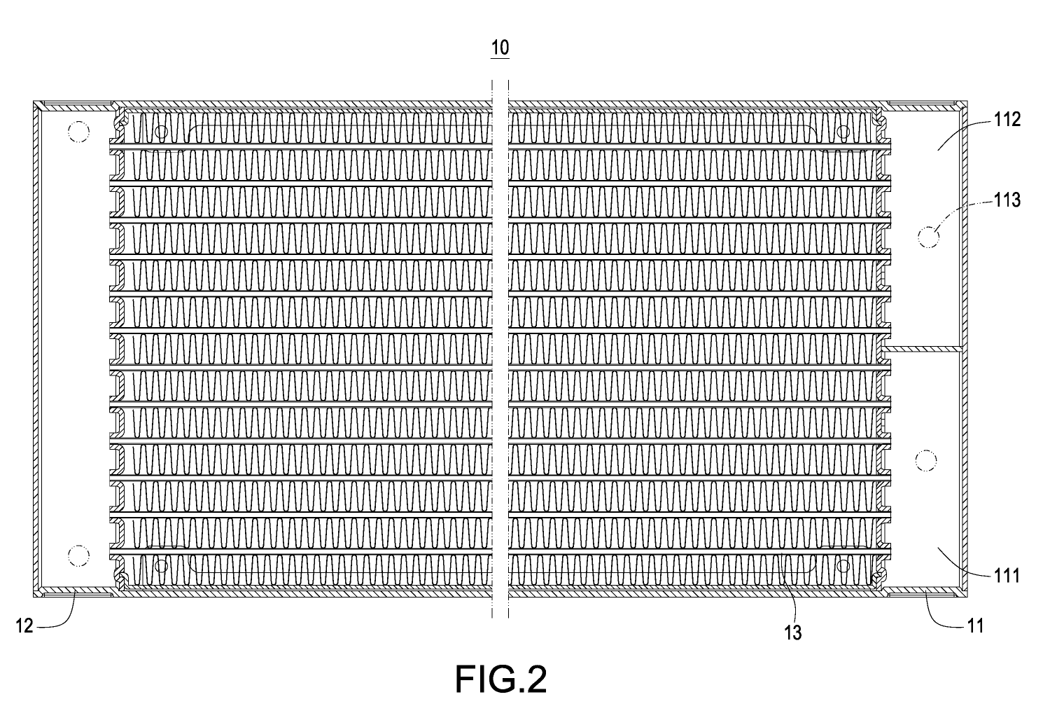

The radiator 10 includes a connecting tank 11, a transition tank 12 opposite to the connecting tank 11, and a plurality of cooling fins 13 connected between the connecting tank 11 and the transition tank 12. In the embodiment, both the connecting tank 11 and the transition tank 12 have an elongated strip shape, but the present disclosure is not limited to this embodiment. The connecting tank 11 has an inlet chamber 111 and an outlet chamber 112 adjacent to each other, as shown in FIG. 2. The inlet chamber 111 is used for connecting the inlet tube A1, and the outlet chamber 112 is used for connecting the outlet tube A2. In detail, a pair of tube joints 113 are arranged on the connecting tank 11 and respectively used for connecting the inlet tube A1 and the outlet tube A2. In the embodiment, each of the cooling fins 13 includes a flat tube (not labeled in figures) and a wavy fin (not labeled in figures) connected to a side of the flat tube, but the present disclosure is not limited to this embodiment. Two ends of some of the cooling fins 13 are respectively communicated to the inlet chamber 111 and the transition tank 12, and two ends of the others are respectively communicated to the outlet chamber 112 and the transition tank 12. In other words, the coolant flows from the liquid cooling head A through the inlet tube A1 into the inlet chamber 111, the coolant then flows through some of the cooling fins 13 to enter the connecting tank 11, the coolant then flows through the others to enter the outlet chamber 112, and the coolant finally passes through the outlet tube A2 to flow back to the liquid cooling head A to form the loop.

The leakage detection module 20 is arranged on the transition tank 12. In the embodiment, the leakage detection module 20 is arranged on a top of the transition tank 12, but the present disclosure is not limited to this embodiment. For example, the leakage detection module 20 may also be arranged on a side or a bottom of the transition tank 12. The leakage detection module 20 includes an additional tank 21, an elastic bladder 22, and a monitoring assembly 23. The additional tank 21 is arranged on the transition tank 12 and communicated to the transition tank 12. In the embodiment, a size of the additional tank 21 is approximately equal to or similar to a size of the transition tank 12, but the present disclosure is not limited to this embodiment. The elastic bladder 22 is arranged in the additional tank 21, and the elastic bladder 22 is filled with air to have a pressure value. The elastic bladder 22 is made of flexible materials with elasticity, such as rubber, silicone, nylon, polyester fiber, polyvinyl chloride (PVC), or polyethylene (PE), so as to expand or contract in response to changes in air pressure. The monitoring assembly 23 is arranged on the additional tank 21 to detect the pressure value of the elastic bladder 22.

Therefore, since the additional tank 21 is communicated to the transition tank 12, the coolant is filled in the liquid cooling head A, the inlet tube A1, the outlet tube A2, the connecting tank 11, the transition tank 12, the cooling fins 13, and the additional tank 21 at the same time. In other words, all of the liquid cooling head A, the inlet tube A1, the outlet tube A2, the connecting tank 11, the transition tank 12, the cooling fins 13, and the additional tank 21 are filled with the coolant without air, such that the coolant may expel the air inside the elastic bladder 22 to outside when filling, so as to make the pressure value negative (that is the elastic bladder 22 is under negative pressure). Therefore, when the liquid cooling device does not leak, a volume of the elastic bladder 22 remains unchanged such that the pressure value of the elastic bladder 22 detected by the monitoring assembly 23 also remains unchanged. When the liquid cooling device leaks, the volume of the elastic bladder 22 changes such that the pressure value of the elastic bladder 22 changes and is detected by the monitoring assembly 23. The monitoring assembly 23 may transmit signals wirelessly or via wired transmission to a controller of the liquid cooling device to issue warnings (such as warning lights, buzzers, or vibration actuators) to alert the user to a leak.

In this way, the monitoring assembly 23 detects the pressure value of the elastic bladder 22, and the liquid cooling head A, the inlet tube A1, the outlet tube A2, the connecting tank 11, the transition tank 12, the cooling fins 13, and the additional tank 21 are communicated to each other. Therefore, regardless of where the liquid cooling device leaks, and whether it is a serious leak or a minor leak, the volume and pressure value of the elastic bladder 22 will change and be detected by the monitoring assembly 23, so as to achieve accurate monitoring. In addition, since the additional tank 21 is arranged on the transition tank 12 and communicated to the transition tank 12, such that the coolant originally contained in the transition tank 21 may be used as a temporary backup even in the event of leakage, so as to prevent the liquid cooling device of the present disclosure from failing to dissipate heat effectively due to insufficient coolant before the user has dealt with the leak.

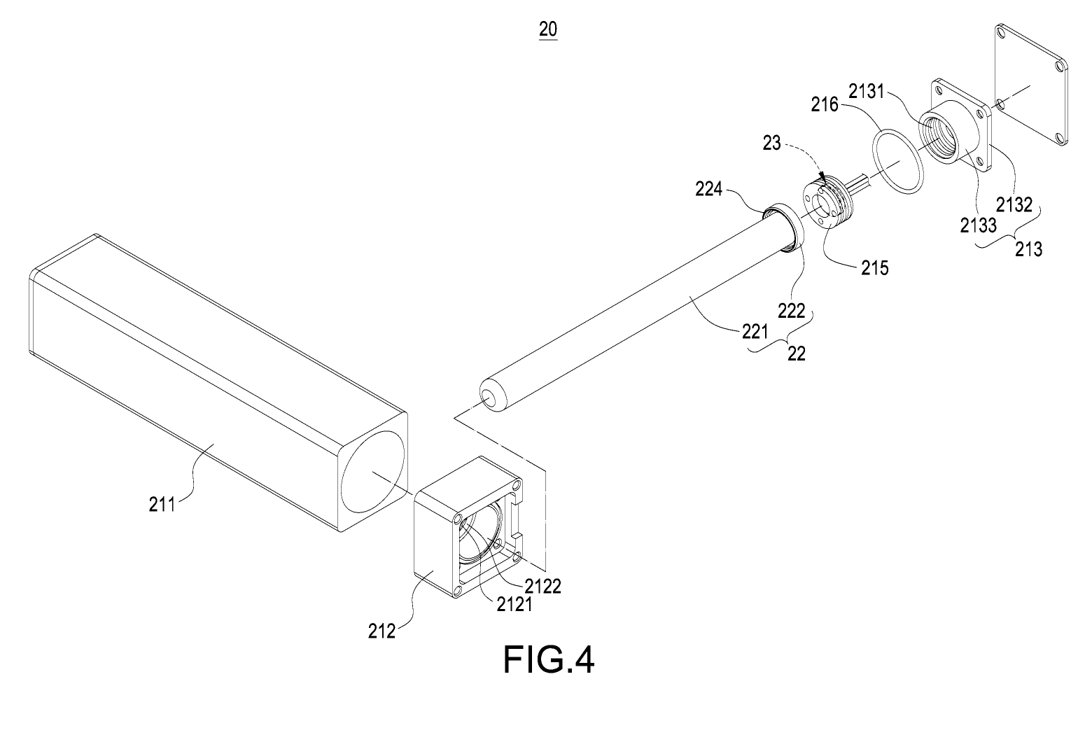

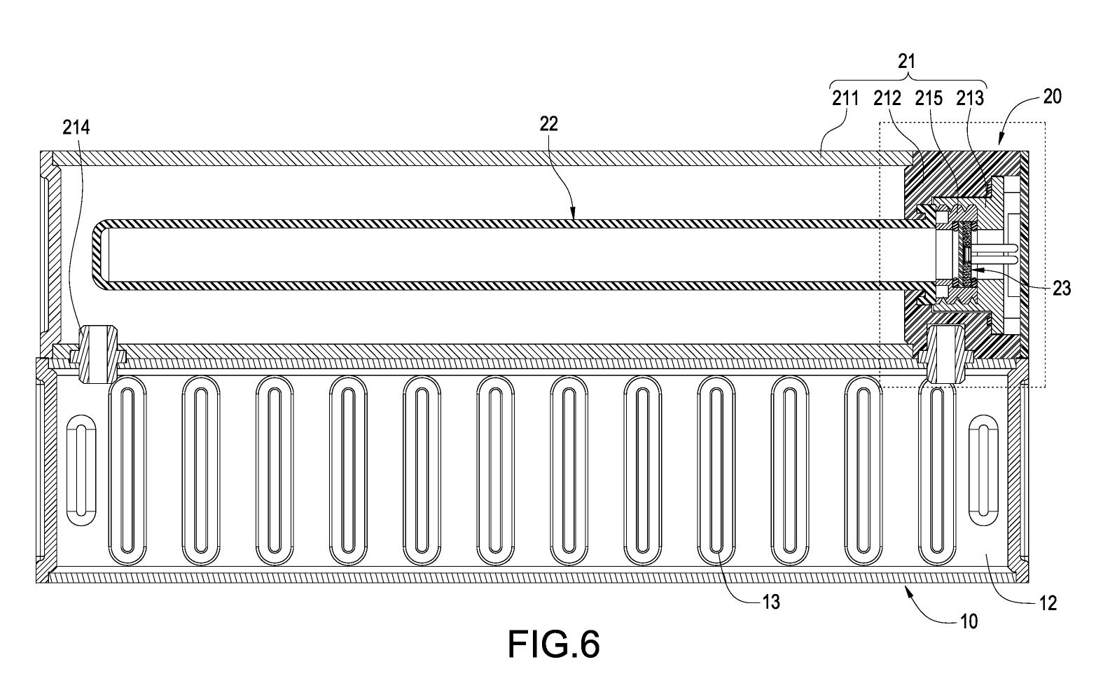

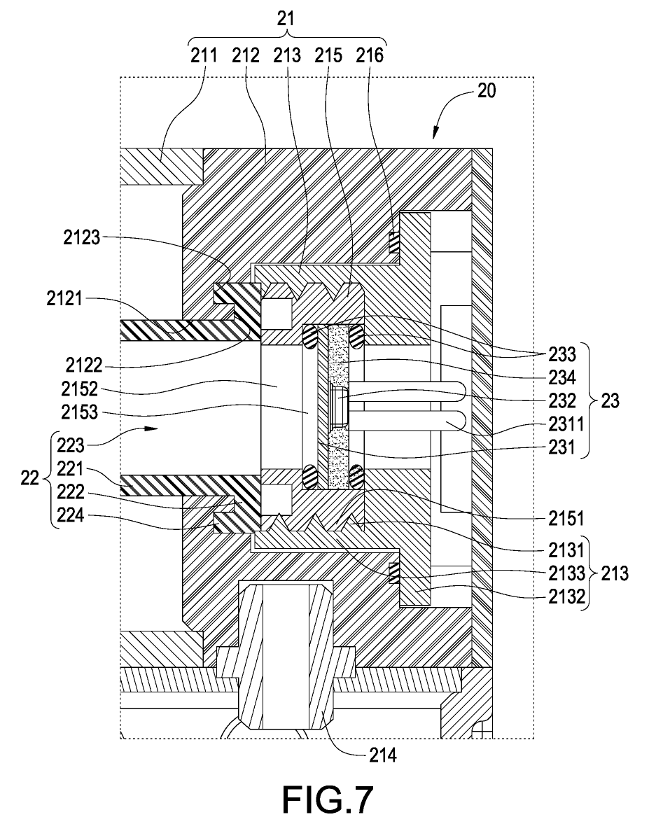

Please refer to FIGS. 4, 5, 6 and 7. Details are provided as follows. The additional tank 21 includes a hollow casing 211, a connecting seat 212, and a sealing cover 213. The hollow casing 211 is arranged on the transition tank 12, and the hollow casing 211 is communicated to the transition tank 12 through a connecting head 214. The connecting seat 212 is arranged on a side of the hollow casing 211. In the embodiment, the connecting seat 212 is fixed to one end of the hollow casing 211 through a plurality of screws (not shown in figures), but the present disclosure is not limited to this embodiment. The elastic bladder 22 penetrates (extends through) the connecting seat 212 to make most part of the elastic bladder 22 be accommodated in the hollow casing 211. The monitoring assembly 23 is arranged on the connecting seat 212, and the monitoring assembly 23 is corresponding to another part of the elastic bladder 22 to detect the pressure value of the elastic bladder 22. The sealing cover 213 is arranged on the connecting seat 212, and the sealing cover 213 seals and covers the monitoring assembly 23 and the part of the elastic bladder 22 corresponding to the monitoring assembly 23. In the embodiment, the sealing cover 213 is fixed to the connecting seat 212 through a plurality of screws (not shown in figures), but the present disclosure is not limited to this embodiment.

In detail, the connecting seat 212 has a through slot 2121 and an abutting surface 2122, and the elastic bladder 22 has a pouch 221, a fixing portion 222, and a cavity 223. The abutting surface 2122 is located in the through slot 2121, and the abutting surface 2122 is perpendicular to an arrangement direction of the through slot 2121. The pouch 221 penetrates (extends through) the through slot 2121, so as to make the fixing portion 222 abut against the abutting surface 2122 to position. The cavity 223 is extended from the fixing portion 222 toward an interior of the pouch 221 to form an elongated strip-shaped space inside the elastic bladder 22. In order to improve the stability and the sealing performance between the elastic bladder 22 and the connecting seat 212, the connecting seat 212 of the embodiment further has an annular groove 2123, and the elastic bladder 22 further has a positioning convex ring 224. The annular groove 2123 of the connecting seat 212 is concave from the abutting surface 2122, and the positioning convex ring 224 is extended from the fixing portion 222. The positioning convex ring 224 is fixed in the annular groove 2123, so as to stably latch the fixing portion 222 on the connecting seat 212 and improve the sealing performance between the elastic bladder 22 and the connecting seat 212 to avoid the coolant leakage between them.

In addition, the additional tank 21 further includes a pressing member 215. The pressing member 215 is cylindrical and is accommodated in the sealing cover 213, such that the fixing portion 222 is clamped and fixed between the connecting seat 212 and the pressing member 215, so as to further improve the stability and the sealing performance between the elastic bladder 22 and the connecting seat 212. In the embodiment, the pressing member 215 has an outer thread 2151, the sealing cover 213 has an inner thread 2131, such that the outer thread 2151 of the pressing member 215 is threadedly engaged with the inner thread 2131 of the sealing cover 213 to fix the pressing member 215 in the sealing cover 213, but the present disclosure is not limited to this embodiment. In detail, the sealing cover 213 includes a cover plate 2132 and a sleeve 2133. The sleeve 2133 is extended from the cover plate 2132 and accommodated in the through slot 2121, and an inner edge of the sleeve 2133 forms the inner thread 2131. An outer wall of the pressing member 215 has the outer thread 2151, and the pressing member 215 is accommodated in the sleeve 2133 by screwing. Therefore, the pressing member 215 may be pre-screwed in the sleeve 2133 of the sealing cover 213, and the sealing cover 213 is then mounted to the connecting seat 212 to clamp and fix the fixing portion 222 of the elastic bladder 22 through the pressing member 215. In addition, the additional tank 21 further includes a sealing washer 216. The sealing washer 216 is adapted to sheathe an outer wall of the sleeve 2133 and is elastically abutted between the connecting seat 212 and the cover plate 2132 of the sealing cover 213, so as to avoid the coolant leakage from the connecting seat 212 and the sealing cover 213.

Details are provided as follows. The pressing member 215 has a through hole 2152 and an accommodated groove 2153 communicated to each other and configured coaxially. The accommodated groove 2153 is communicated to the cavity 223 through the through hole 2152, that is the accommodated groove 2153 is located on a side of the pressing member 215 away from the elastic bladder 22. The monitoring assembly 23 is accommodated in the accommodated groove 2153 of the pressing member 215, and the monitoring assembly 23 mainly includes a circuit board 231, a sensor 232, and a pair of waterproof rings 233. The sensor 232 is arranged on one side of the circuit board 231. In the embodiment, the sensor 232 is arranged on a side of the circuit board 231 away from the elastic bladder 22 and communicated to the cavity 223 of the elastic bladder 22 through a via hole of the circuit board 231, so as to facilitate the arrangement of a plurality of wires 2311 of circuit board 231, but the present disclosure is not limited to this embodiment. An outer edge of each of the waterproof rings 233 is fixed in an inner wall of the accommodated groove 2153, a side edge of each of the waterproof rings 233 is elastically abutted against two opposite sides of the circuit board 231, and the waterproof ring 233 located on same side with the sensor 232 surrounds the sensor 232, so as to efficiently prevent the coolant from leaking to the circuit of the circuit board 231 and the sensor 232. In addition, in order to further improve the waterproof of the sensor 232, the monitoring assembly 23 of the embodiment further includes an encapsulation layer 234 sealing and covering the whole sensor 232, but the present disclosure is not limited to this embodiment.

In the liquid cooling device of the present disclosure, the additional tank 21 is communicated to the transition tank 12, such that the coolant may be filled into the connecting tank 11, the transition tank 12, the cooling fins 13, and the additional tank 14. In addition, the monitoring assembly 23 detects the pressure value of the elastic bladder 22 in the additional tank 21. Therefore, the volume of the elastic bladder 22 changes when the liquid cooling device leaks, such that the pressure value changes and is detected by the monitoring assembly 23, so as to accurately monitor the entire liquid cooling device for leakage to allow users to handle them immediately.

It shall be understood that the present disclosure may have other types of embodiments, and a person with ordinary skills in the art of the technical field of the present disclosure may make various changes and modifications corresponding to the present disclosure without deviating the principle and substance of the present disclosure; however, such corresponding changes and modification shall be considered to be within the claimed scope of the present disclosure.

What is claimed is:

1. A liquid cooling device for connecting an inlet tube and an outlet tube of a liquid cooling head to form a closed loop for a coolant flowing therein, the liquid cooling device comprising:
a radiator, comprising a connecting tank, a transition tank, and a plurality of cooling fins, the connecting tank comprising an inlet chamber and an outlet chamber adjacent to each other, two ends of some of each of the cooling fins respectively communicated to the inlet chamber and the transition tank, two ends of the others of each of the cooling fins respectively communicated to the outlet chamber and the transition tank, the inlet chamber configured to connect the inlet tube, the outlet chamber configured to connect the outlet tube; and
a leakage detection module, arranged on the transition tank and comprising an additional tank, an elastic bladder, and a monitoring assembly, the additional tank communicated to the transition tank, the elastic bladder arranged in the additional tank and comprising a pressure value, the monitoring assembly arranged on the additional tank to detect the pressure value;
wherein the coolant is filled in the liquid cooling head, the inlet tube, the outlet tube, the connecting tank, the transition tank, the cooling fins, and the additional tank;
wherein when the liquid cooling device leaks, a volume of the elastic bladder changes such that the pressure value changes and is detected by the monitoring assembly.

2. The liquid cooling device according to claim 1, wherein the additional tank comprises a hollow casing, a connecting seat, and a sealing cover, the hollow casing is arranged on the transition tank and communicated to the transition tank, the connecting seat is arranged on a side of the hollow casing, the elastic bladder penetrates the connecting seat to make a part of the elastic bladder be accommodated in the hollow casing, the monitoring assembly is arranged on the connecting seat and corresponding to another part of the elastic bladder, the sealing cover is arranged on the connecting seat and seals and covers the monitoring assembly and the part of the elastic bladder corresponding to the monitoring assembly.

3. The liquid cooling device according to claim 2, wherein the connecting seat comprises a through slot and am abutting surface located in the through slot, the elastic bladder comprises a pouch, a fixing portion, and a cavity, the pouch penetrates the through slot to make the fixing portion abut against the abutting surface, the cavity is extended from the fixing portion toward an interior of the pouch.

4. The liquid cooling device according to claim 3, wherein the connecting seat further comprises an annular groove, the annular groove is concave from the abutting surface, the elastic bladder further comprises a positioning convex ring, the positioning convex ring is extended from the fixing portion and fixed in the annular groove.

5. The liquid cooling device according to claim 3, wherein the additional tank further comprises a pressing member, the pressing member is accommodated in the sealing cover, the fixing portion is clamped between the connecting seat and the pressing member.

6. The liquid cooling device according to claim 5, wherein the pressing member comprises an outer thread, the sealing cover comprises an inner thread, the outer thread is threadedly engaged with the inner thread to fix the pressing member in the sealing cover.

7. The liquid cooling device according to claim 5, wherein the pressing member comprises a through hole and an accommodated groove communicated to each other and configured coaxially, the accommodated groove is communicated to the cavity through the through hole, the monitoring assembly is accommodated in the accommodated groove and comprises a circuit board, a sensor, and a pair of waterproof rings, the sensor is arranged on the circuit board, each of the waterproof rings is fixed in the accommodated groove and abutted against two opposite sides of the circuit board.

8. The liquid cooling device according to claim 7, wherein the sensor is arranged on one side of the circuit board and surrounded by the corresponding waterproof ring.

9. The liquid cooling device according to claim 7, wherein the sealing cover comprises a cover plate and a sleeve, the sleeve is extended from the cover plate and accommodated in the through slot, the pressing member is accommodated in the sleeve.

10. The liquid cooling device according to claim 9, wherein the additional tank further comprises a sealing washer, the sealing washer is adapted to sheathe the sleeve and elastically abutted between the connecting seat and the cover plate.
